(19) United States
(12) Patent Application Publication
(10) Pub. No.: US 2022/0102721 A1
(43) Pub. Date: Mar. 31, 2022

(54) PRELITHIATION SOLUTION FOR GRAPHITE OR GRAPHITE COMPOSITE ANODE AND PRELITHIATION METHOD USING SAME

(71) Applicant: KOREA INSTITUTE OF SCIENCE AND TECHNOLOGY, Seoul (KR)

(72) Inventors: Minah LEE, Seoul (KR); Jihyun HONG, Seoul (KR); Kyung Yoon CHUNG, Seoul (KR); Jin Kwan CHOI, Seoul (KR); Ju Young JANG, Seoul (KR)

(73) Assignee: KOREA INSTITUTE OF SCIENCE AND TECHNOLOGY, Seoul (KR)

(21) Appl. No.: 17/217,413

(22) Filed: Mar. 30, 2021

(30) Foreign Application Priority Data
Sep. 28, 2020 (KR) 10-2020-0125635

(51) Int. Cl. H01M 4/583; H01M 10/0525; H01M 4/38; H01M 10/0569; H01M 10/0568; H01M 4/525; H01M 4/505; H01M 4/62; H01M 4/04

(52) U.S. Cl. CPC H01M 4/583; H01M 10/0525; H01M 4/386; H01M 10/0569; H01M 2300/002; H01M 4/525; H01M 4/505; H01M 4/623; H01M 4/049; H01M 10/0568

(57) ABSTRACT

The present disclosure provides a prelithiation solution for a graphite or graphite/silicon composite anode, which includes: (a) a cyclic or linear ether-based solvent; and (b) an aromatic hydrocarbon-lithium complex, and has a reduction potential of 0.25 V (vs Li/Li⁺) or lower.

According to the present disclosure, lithium ions can be chemically intercalated uniformly throughout a graphite or graphite composite anode in solution phase and a high level of prelithiation may be achieved. In addition, an anode having an initial coulombic efficiency close to 100% may be provided by prelithiating a graphite or graphite composite anode using the prelithiation solution and a commercially applicable lithium secondary battery exhibiting high energy density may be provided based thereon.

### CROSS-REFERENCE TO RELATED APPLICATIONS

This application claims priority under 35 U.S.C. § 119 to Korean Patent Application No. 10-2020-0125635 filed on Sep. 28, 2020 in the Korean Intellectual Property Office, the disclosure of which is incorporated herein by reference in its entirety.

### TECHNICAL FIELD

The present disclosure relates to a prelithiation solution for a graphite or graphite composite anode and a prelithiation method using the same, more specifically to a method for obtaining a prelithiation solution for a graphite or graphite composite anode, having a reduction potential of 0.25 V (vs Li/Li⁺) or lower, by dissolving an aromatic hydrocarbon-lithium complex in an ether-based solvent and prelithiating a graphite or graphite composite anode using the same.

### BACKGROUND

The energy density of a lithium-ion battery is determined by the number of Li ions transferred in an electrochemical reaction involved per cell volume (or mass) and the voltage of the cell. In a practical cell, irreversible electrochemical reduction of electrolytes occurs, which forms a solid-electrolyte interphase (SEI) on an anode in the initial cycle. This consumes the active lithium ions originally loaded in a cathode prior to cycling and thus lowers the coulombic efficiency of the battery operation.

The decreased active lithium ion content significantly limits the available energy density of a battery in the following cycles. Graphite, a commercial anode for lithium-ion batteries, typically exhibits an initial coulombic efficiency of around 90%, whereas silicon and silicon oxides (SiOₓ), which are next-generation high-capacity anode materials, exhibit an initial coulombic efficiency of lower than 80%, which prevents their commercial application.

To achieve a high initial coulombic efficiency and the maximum energy density, prelithiation prior to battery assembly has been attempted so that the extra lithium ions compensate for the loss of active lithium ions in the electrode. For this purpose, addition of solid lithium particles or lithium compounds as sacrificial lithium sources when preparing electrodes has been proposed. However, nanosized additives are difficult and dangerous to synthesize at larger scale, typically require use of unconventional solvents for electrode preparation, and inevitably lead to the presence of impurities in the electrode, lowering net energy density.

An alternative approach is to directly apply lithium metal to prelithiate the electrode. However, the physical contact with lithium metal has the problem that precise control of the lithium dose is difficult. Whereas a method of binding a temporary electrochemical cell having an anode as lithium metal has been proposed for prelithiation of the electrode, it is not suitable for commercialization because a re-assembly step is required for battery fabrication.

Recently, graphite/silicon composites and carbon/silicon composites of similar concept are drawing attentions as next-generation anode materials that can make up for the low capacity of graphite and the low coulombic efficiency and life characteristics of silicon-based materials. The composite anode also exhibits low initial efficiency of below 90% due to irreversible reactions occurring on the surface of the silicon-based anode and a prelithiation is required for maximizing the energy density of the battery. It is known that the initial efficiency can be increased to 100% by a prelithiation method using a reducing solution containing linear or cyclic ethers through a chemical reaction of intercalating active lithium into the silicon-based anode. However, when the composite electrode is treated with a reducing solution containing linear or cyclic ethers, the crystal structure of graphite may be destroyed irreversibly via a reaction whereby the solvent is decomposed after the intercalation of solvated lithium ions into the graphite occurs.

The inventors of the present disclosure have consistently researched on the prelithiation of a graphite or graphite composite anode. They have found out that an anode prelithiated using a prelithiation solution with a reduction potential of 0.25 V (vs Li/Li⁺) or lower, prepared by dissolving an aromatic hydrocarbon-lithium complex in a cyclic or linear ether-based solvent, has an initial coulombic efficiency close to 100% while retaining the crystal structure of graphite without being destroyed and a commercially applicable lithium secondary battery exhibiting high energy density can be prepared therefrom, and have completed the present disclosure.

### REFERENCES OF THE RELATED ART

### Non-Patent Documents

(Non-patent document 1) Holtstiege, F., Bärmann, P., Nolle, R., Winter, M. & Placke, T. Pre-lithiation strategies for rechargeable energy storage technologies: Concepts, promises and challenges. Batteries 4, 4 (2018).

(Non-patent document 2) Sun, Y. et al. High-capacity battery cathode prelithiation to offset initial lithium loss. Nat. Energy 1, 1-7 (2016).

### SUMMARY

The present disclosure is directed to providing a prelithiation solution with a reduction potential 0.25 V (vs Li/Li⁺) or lower, which is capable of chemically intercalating lithium ions uniformly throughout a graphite or graphite composite anode in solution phase and capable of achieving high level of prelithiation.

The present disclosure is also directed to providing an anode having an initial coulombic efficiency close to 100% by prelithiating a graphite or graphite composite anode using the prelithiation solution and a commercially applicable lithium secondary battery exhibiting high energy density based thereon.

The present disclosure provides a prelithiation solution for a graphite or graphite composite anode, which includes: (a) a cyclic or linear ether-based solvent; and (b) an aromatic hydrocarbon-lithium complex, and has a reduction potential of 0.25 V (vs Li/Li⁺) or lower.

The cyclic or linear ether-based solvent has a ratio of oxygen elements to carbon elements in the solvent of 0.25 or lower (0:C≤0.25).

The aromatic hydrocarbon is a substituted or unsubstituted polycyclic aromatic compound having 10-22 carbon atoms except the substituent.

The present disclosure also provides a graphite or graphite composite anode prelithiated with the prelithiation solution.

The present disclosure also provides a lithium secondary battery including: the prelithiated graphite or graphite composite anode; a cathode; and an electrolyte.

The present disclosure also provides a method for preparing a prelithiated graphite or graphite composite anode, which includes (I) a step of preparing an anode including a graphite or graphite composite active material layer formed on one or both surface(s) of a current collector; and (II) a step of immersing the anode in a prelithiation solution including a cyclic or linear ether-based solvent and an aromatic hydrocarbon-lithium complex and having a reduction potential of 0.25 V (vs Li/Li⁺) or lower.

According to the present disclosure, a prelithiation solution with a reduction potential 0.25 V (vs Li/Li⁺) or lower, which is capable of chemically intercalating lithium ions uniformly throughout a graphite or graphite composite anode in solution phase and capable of achieving high level of prelithiation, may be provided. In addition, an anode having an initial coulombic efficiency close to 100% may be provided by prelithiating a graphite or graphite composite anode using the prelithiation solution and a commercially applicable lithium secondary battery exhibiting high energy density may be provided based thereon.

### BRIEF DESCRIPTION OF DRAWINGS

FIGS. 1A to 1D show the voltage curves of graphite electrodes prelithiated using prelithiation solutions of Examples 1-2 and Comparative Example 1 (FIG. 1A: pristine graphite as a control group, FIG. 1B: Example 1, FIG. 1C: Example 2, and

FIG. 1D: Comparative Example 1).

FIGS. 2A to 2C show the scanning electron microscopy (SEM) images of graphite electrodes prelithiated using prelithiation solutions of Example 1 and Comparative Example 1 (FIG. 2A: pristine graphite as a control group, FIG. 2B: Example 1, and FIG. 2C: Comparative Example 1).

FIGS. 3A to 3D show the voltage curves of graphite electrodes prelithiated using prelithiation solutions of Examples 3-5 and Comparative Example 2 (FIG. 3A: Example 3, FIG. 3B: Example 4, FIG. 3C: Example 5, and FIG. 3D: Comparative Example 2).

FIGS. 4A and 4B show the voltage curve of a graphite/silicon composite (graphite/SiOₓ) electrode prelithiated using a prelithiation solution of Example 6 (FIG. 4A: pristine graphite/silicon composite as a control group and FIG. 4B: Example 6).

FIGS. 5A and 5B show the voltage profile of a full-cell prelithiated using a prelithiation solution of Example 6 during the initial electrochemical cycle (FIG. 5A: LiNi_{0.5}Mn_{0.3}Co_{0.2}O₂∥pristine graphite/silicon full-cell and FIG. 5B: LiNi_{0.5}Mn_{0.3}Co_{0.2}O₂∥Example 6 graphite/silicon composite full-cell).

FIG. 6 shows the life characteristics of the full-cell shown in FIGS. 5A and 5B based on the total mass of a cathode and an anode.

### DETAILED DESCRIPTION OF EMBODIMENTS

Hereinafter, a prelithiation solution for a graphite or graphite composite anode according to the present disclosure and a prelithiation method using the same are described in detail through examples and comparative examples as well as the attached drawings.

First, the present disclosure provides a prelithiation solution for a graphite or graphite composite anode, which includes: (a) a cyclic or linear ether-based solvent; and (b) an aromatic hydrocarbon-lithium complex, and has a reduction potential of 0.25 V (vs Li/Li⁺) or lower.

Unlike other prelithiation methods, chemical prelithiation is advantageously applicable to large-scale production because of unique reaction homogeneity and simplicity. With the existing chemical prelithiation method, it was possible to improve initial coulombic efficiency using a lithium-containing reductive compound or partly improve coulombic efficiency by forming an SEI during pretreatment by forming a protective film. However, an ideal active lithium content could not be attained because sufficiently high reducing strength (sufficiently low redox potential) was not achieved.

However, it was found out that the prelithiation solution according to the present disclosure has a low redox potential of 0.25 V (vs Li/Li⁺) or lower and has a sufficient reducing strength for prelithiation. In particular, the prelithiation solution according to the present disclosure enables successful chemical prelithiation of a graphite or graphite composite anode and enables uniform intercalation of lithium throughout the electrode.

The prelithiation solution for a graphite or graphite composite anode according to the present disclosure includes a cyclic or linear ether-based solvent as an essential component.

Specifically, the cyclic or linear ether-based solvent may have a ratio of oxygen elements to carbon elements in the solvent of 0.25 or lower (O:C≤0.25). If the ratio of oxygen elements to carbon elements in the cyclic or linear ether-based solvent exceeds 0.25, i.e., if the cyclic or linear ether-based solvent has high solvation power, it is impossible to process a high-capacity anode such as graphite or a graphite composite. That is to say, exfoliation of graphite may occur due to co-intercalation of the large-sized solvated lithium ions. Therefore, it is necessary to prevent the co-intercalation of the solvated lithium ions into graphite and allow only the intercalation (doping) of desolvated lithium ions.

As the cyclic ether-based solvent having a ratio of oxygen elements to carbon elements of 0.25 or lower, one or more selected from a group consisting of methyldioxolane, dimethyldioxolane, vinyldioxolane, ethylmethyldioxolane, oxane, tetrahydrofuran, methyltetrahydrofuran, dimethyltetrahydrofuran, ethoxytetrahydrofuran, ethyltetrahydrofuran, dihydropyran, tetrahydropyran, methyltetrahydropyran, dimethyltetrahydropyran, hexamethylene oxide, furan, dihydrofuran, dimethoxybenzene and dimethyloxetane may be used. More specifically, methyltetrahydrofuran or tetrahydropyran may be used.

In addition, as the linear ether-based solvent having a ratio of oxygen elements to carbon elements of 0.25 or lower, one or more selected from a group consisting of ethylene glycol dibutyl ether, methoxypropane, ethyl propyl ether, diethylether, ethyl propyl ether, dipropyl ether, diisopropyl ether, dibutyl ether, diisobutyl ether and ethyl t-butyl ether may be used.

In addition, the prelithiation solution for a graphite or graphite composite anode according to the present disclosure includes an aromatic hydrocarbon-lithium complex as an essential component. For ideal chemical lithiation of the anode, it is necessary to adjust the electrochemical potential of the prelithiation solution lower than the potential of the anode. The aromatic hydrocarbon may be a substituted or unsubstituted polycyclic aromatic compound having 10-22 carbon atoms except the substituent. An aromatic hydrocarbon having fewer than 10 carbon atoms cannot form a solution of lithium ions and aromatic hydrocarbon complexes because the reduction potential is lower than that of lithium. And, if the number of carbon atoms exceeds 22, reducing strength may be insufficient due to high reduction potential.

For example, as the aromatic hydrocarbon, substituted or unsubstituted naphthalene, anthracene, phenanthrene, tetracene, azulene, fluoranthene, phenylanthracene, diphenylanthracene, perylene, pyrene, triphenylene, bianthryl, biphenyl, terphenyl, quaterphenyl, stilbene, etc. may be used. More specifically, substituted or unsubstituted biphenyl or naphthalene may be used.

The substituted aromatic hydrocarbon may contain one or more substituent selected from a group consisting of a C₁₋₆ alkyl group, a C₆₋₂₀ aryl group, a C₁₋₁₀ alkoxy group and a C₁₋₆ alkyl halide. More specifically, it may contain a C₁₋₄ alkyl group.

Specifically, the substituted or unsubstituted biphenyl or naphthalene may be a compound represented by Chemical Formula 1 or Chemical Formula 2.

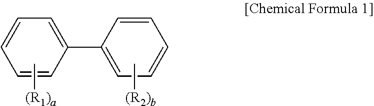

In Chemical Formula 1, each of R₁ and R₂, which are identical to or different from each other, is independently a hydrogen atom, C₁₋₆ alkyl, C₆₋₂₀ aryl, C₁₋₁₀ alkoxy or C₁₋₆ alkyl halide, and a and b are integers from 1 to 5.

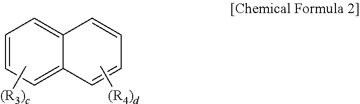

In Chemical Formula 2, each of R₃ and R₄, which are identical to or different from each other, is independently a hydrogen atom, C₁₋₆ alkyl, C₆₋₂₀ aryl, C₁₋₁₀ alkoxy or C₁₋₆ alkyl halide, and c and d are integers from 1 to 4.

The prelithiation solution according to the present disclosure forms a protective film on the surface of the electrode. The formed protective film provides advantage to the preparation process because it ensures the stability of the prelithiated electrode in dry air.

According to a specific exemplary embodiment, in Chemical Formula 1, each of R₁ and R₂, which are identical to or different from each other, is a hydrogen atom or C₁₋₄ alkyl, and a and b are integers from 1 to 2. In addition, in Chemical Formula 2, each of R₃ and R₄, which are identical to or different from each other, is independently a hydrogen atom or C₁₋₄ alkyl, and c and d are integers from 1 to 2. The complex of a lithium ion and the substituted or unsubstituted aromatic hydrocarbon according to the present disclosure can be used for chemical prelithiation of a graphite or graphite composite anode because it has a sufficiently low reduction potential as compared to a silicon-based anode and exhibits an initial coulombic efficiency close to 100% since the initial coulombic efficiency is remarkably improved as compared to the pristine silicon-based anode.

More specifically, the substituted or unsubstituted biphenyl or naphthalene compound represented by Chemical Formula 1 or Chemical Formula 2 may be one or more selected from a group consisting of the compounds represented by Chemical Formulas 1-1 to 1-3 and 2-1 to 2-3.

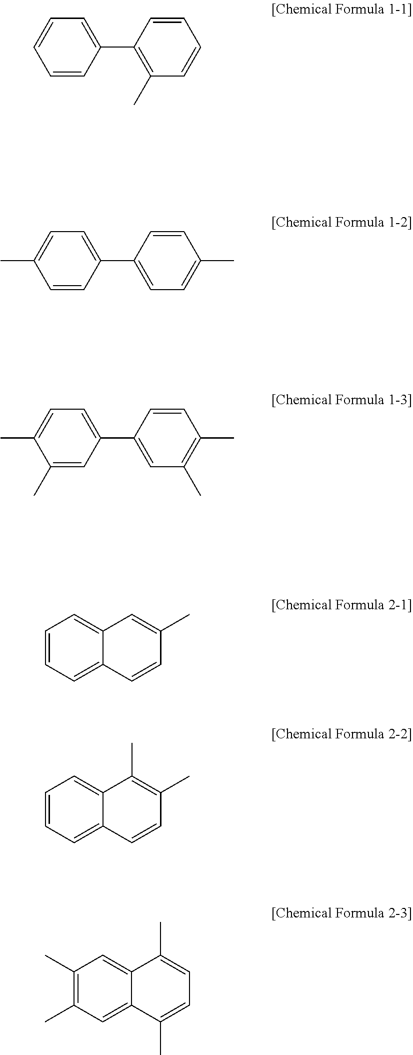

The present disclosure also provides a graphite or graphite composite anode prelithiated with the prelithiation solution described above.

The graphite composite anode may include one or more selected from a group consisting of silicon (Si), silicon oxide (SiOₓ), silicon carbide (SiC), germanium (Ge), aluminum (Al), tin (Sn), gold (Au), silver (Ag), phosphorus (P), hard carbon and soft carbon, which may serve as an additive or support for the anode.

The present disclosure also provides a lithium secondary battery including: the prelithiated graphite or graphite composite anode; a cathode; and an electrolyte.

The present disclosure also provides a method for preparing a prelithiated graphite or graphite composite anode, which includes (I) a step of preparing an anode including a graphite or graphite composite active material layer formed on one or both surface(s) of a current collector; and (II) a step of immersing the anode in a prelithiation solution including a cyclic or linear ether-based solvent and an aromatic hydrocarbon-lithium complex and having a reduction potential of 0.25 V (vs Li/Li⁺) or lower.

The method for preparing a prelithiated graphite or graphite composite anode according to the present disclosure is advantageous in that a prelithiated anode is prepared via a simple process of immersing the anode in a prelithiation solution. The prepared prelithiated anode is stable for a long time in dry air because a protective film is formed on the surface of the electrode. Therefore, the method is applicable to large-scale production of lithium secondary batteries unlike the existing method which requires a complicated condition for prelithiation.

Description about the prelithiation solution including a cyclic or linear ether-based solvent and an aromatic hydrocarbon-lithium complex and having a reduction potential of 0.25 V (vs Li/Li⁺) or lower will be omitted because it has been already described above.

The concentration of the aromatic hydrocarbon-lithium complex in the prelithiation solution may be in a range from 10 mmol/L to 5 mol/L. In the concentration range from 10 mmol/L to 5 mol/L, the reduction potential of the complex is typically decreased and the improved reducing strength may lead to improved initial coulombic efficiency. If the concentration is below 10 mmol/L, prelithiation reaction may not occur sufficiently because the reduction potential is too high. And, if the concentration exceeds 5 mol/L, precipitation may occur depending on the solubility of the aromatic hydrocarbon-lithium complex and undesirable byproducts may remain on the surface of the electrode.

The immersion in the step (II) may be performed at−10 to 80° C. Specifically, it may be performed at 10-50° C. In the temperature range from −10 to 80° C., the reduction potential of the complex is typically decreased and the improved reducing strength may lead to improved initial coulombic efficiency. If the temperature is below −10° C., prelithiation reaction may not occur sufficiently because the reduction potential is too high. And, if the temperature exceeds 80° C., precipitation of lithium metal or evaporation of the solvent may occur.

The immersion in the step (II) may be performed for 0.01-1440 minutes, specifically for 1-600 minutes, more specifically for 5-240 minutes. For 5 minutes after the immersion, the initial coulombic efficiency of the prepared anode increases rapidly. The pace of increase decreases gradually at around 30 minutes, and the initial coulombic efficiency is not improved any more after 120 minutes. The open-circuit voltage (OCV) of the cell shows the opposite tendency to the initial coulombic efficiency. Therefore, if the immersion time is shorter than 0.01 minute, it is difficult to except the improvement in anode performance through the prelithiation. And, even if the immersion time exceeds 1440 minutes, no more improvement in the initial coulombic efficiency or decrease in OCV can be expected.

The step (II) may be performed continuously via roll-to-roll process. The roll-to-roll process is performed by a roll-to-roll equipment, and the roll-to-roll equipment includes an unwinder and a rewinder. The unwinder continuously unwinds the anode, and the rewinder continuously rewinds the anode after the process is finished. The unwinder and the rewinder apply tension to the anode for a lithium-ion battery. The anode is supplied continuously by the unwinder and the rewinder. The supplied anode passes through a prelithiation solution accommodation unit accommodating the prelithiation solution, and prelithiation is performed as the anode is immersed in the prelithiation solution accommodated in the accommodation unit. The anode that has passed through the prelithiation solution accommodation unit is rewound by the rewinder. The immersion time in the prelithiation solution may be adjusted by adjusting the speed of the roll-to-roll process or by changing the number, location, etc. of the rolls. The prelithiated anode may pass through an additional solution accommodation unit for washing and may pass through a dryer for removal of the residual solution. Since the prelithiation solution used in the preparation method of the present disclosure is capable of maintaining stability for a long time even in dry air by forming a protective film on the surface of the anode, it is applicable to the roll-to-roll process which allows large-scale production.

Hereinafter, specific examples are presented to help the understanding of the present disclosure. However, the examples are provided to illustrate the present disclosure more specifically, and it will be obvious to those having ordinary knowledge in the art that the scope of the present disclosure is not limited by them and various changes and modifications can be made within the scope and technical idea of the present disclosure.

### [Examples] Preparation of Prelithiation Solution and Prelithiated Anode

### Example 1

A prelithiation solution was prepared by dissolving 0.2 M of a complex of lithium metal slice and biphenyl (BP), which is an aromatic hydrocarbon, in a 2-methyltetrahydrofuran (2-MeTHF) solvent and stirring for 2 hours at 30° C. in a glove box of argon atmosphere. For sufficient supply of lithium, the molar ratio of lithium:biphenyl was fixed to 4:1. Then, a prelithiated anode was prepared by immersing a graphite anode in the prelithiation solution and then quenching additional reactions between the prelithiation solution and the anode by washing with a 1 M LiPF₆ EC/DEC (1:1 v/v) electrolyte.

### Example 2

A prelithiated anode was prepared in the same manner as in Example 1, except that tetrahydropyran (THP) was used as the solvent for preparing the prelithiation solution.

### Comparative Example 1

A prelithiated anode was prepared in the same manner as in Example 1, except that dimethoxyethane (DME) was used as the solvent for preparing the prelithiation solution.

### Example 3

A prelithiated anode was prepared in the same manner as in Example 1, except that tetrahydrofuran (THF) was used as the solvent for preparing the prelithiation solution and naphthalene (NP) was used as the aromatic hydrocarbon.

### Example 4

A prelithiated anode was prepared in the same manner as in Example 1, except that tetrahydropyran (THP) was used as the solvent for preparing the prelithiation solution and naphthalene (NP) was used as the aromatic hydrocarbon.

### Example 5

A prelithiated anode was prepared in the same manner as in Example 1, except that 2-methyltetrahydrofuran (2-MeTHF) was used as the solvent for preparing the prelithiation solution and naphthalene (NP) was used as the aromatic hydrocarbon.

### Comparative Example 2

A prelithiated anode was prepared in the same manner as in Example 1, except that dimethoxyethane (DME) was used as the solvent for preparing the prelithiation solution and naphthalene (NP) was used as the aromatic hydrocarbon.

### Example 6

A prelithiated anode was prepared in the same manner as in Example 1, except that a graphite/silicon composite (graphite/Si) anode was immersed in the prelithiation solution of Example 1.

### [Test Example] Electrochemical Analysis

A water-soluble electrode slurry was prepared by mixing graphite (Hitachi, Japan) or a mixture of graphite and silicon (Wellcos Corporation, Korea) as an active material, carbon black (Super-P, Timcal, Switzerland) and a binder (Aekyung Chemical Co., Ltd., Korea) at a weight ratio of 8.5:0.5:1 for a pristine graphite electrode and 8:1:1 for a graphite/silicon composite electrode using a centrifuge (THINKY Corporation, Japan). The slurry was cast on a Cu-foil current collector, dried at 80° C. for 1 hour, roll-pressed, cut to a diameter of 11.3 mm (area: 1.003 cm²), and then dried in a vacuum oven at 120° C. overnight. The loading amount of the active material on each electrode was 1.0±0.5 mg/cm². A CR2032 coin cell was prepared in an argon-filled glove box using PP/PE/PP as a separator and 1 M LiPF₆ in a mixture of ethylene carbonate (EC) and diethyl carbonate (DEC) (1:1 v/v) as an electrolyte. Electrochemical analysis was carried out using a WBCS-3000 battery cycler (Wonatech Co. Ltd., Korea) and a VMP3 potentio/galvanostat (Bio-logic Scientific Instruments, France). All the electrochemical measurements were performed at 30° C.

For half-cell experiments, the graphite/silicon composite coin cell was discharged with a constant current (+30 mV vs Li), followed by a constant voltage until the current density decayed to 10%, and then recharged to 1.2 V. The current densities for the first two cycles and subsequent cycles were 0.2 C and 0.5 C, respectively, with respect to reversible capacity.

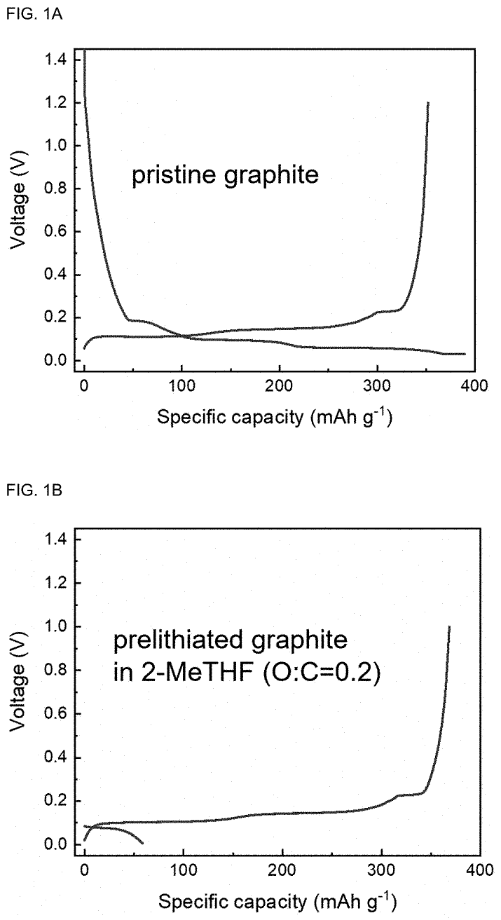

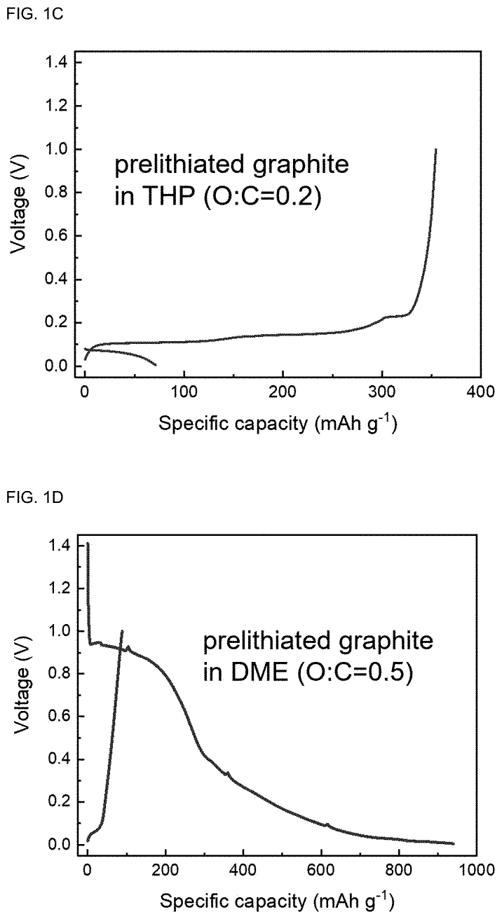

For half-cell experiments, the pristine graphite coin cell was discharged with a constant current (+5 mV vs Li), except for Example 1 of FIGS. 1A to 1D, and then recharged to 1 V. The current density for all the cycles during charging and discharging was 0.1 C with respect to reversible capacity.

For full-cell experiments, a cathode was fabricated by casting a slurry composed of Li(Ni_{0.5}Co_{0.2}Mn_{0.3})O₂ (NCM523) (Wellcos Corporation, Korea), Super P and a polyvinylidene fluoride (PVdF) binder at a weight ratio of 8:1:1 in a N-methyl-2-pyrrolidone (NMP) solvent on a carbon-coated aluminum foil. The diameters of the cathode and the anode were 11.3 mm and 12 mm, respectively. A full cell was designed to have an N/P ratio (the practical capacity ratio of the anode to the cathode) of 1.2. A coin cell was fabricated in the same manner as the half-cell described above except for adding fluoroethylene carbonate (FEC) as an additive.

FIGS. 1A to 1D show the voltage curves of the graphite electrodes prelithiated using the prelithiation solutions of Examples 1-2 and Comparative Example 1 [FIG. 1A: pristine graphite as a control group, FIG. 1B: Example 1, FIG. 1C: Example 2, FIG. 1D: Comparative Example 1].

The electrochemical curve of the conventional pristine graphite shown in FIG. 1A shows an initial efficiency of 91.7%. FIG. 1B shows the result of using 2-methyltetrahydrofuran (2-MeTHF) as a solvent in Example 1 and an initial efficiency of 627% was observed. The higher initial efficiency as compared to the conventional pristine graphite means that chemical lithiation occurred successfully. The same charging curve profile as that of the conventional pristine graphite means that structural failure did not occur during the prelithiation of graphite. FIG. 1C shows the result of using the tetrahydropyran (THP) solvent and an initial efficiency of 497% was observed. It was confirmed that prelithiation was possible without structural failure of graphite when tetrahydropyran was used as the solvent. In contrast, when dimethoxyethane (DME) was used as a solvent, a discharging curve was observed around 0.9 V unlike the conventional pristine graphite and capacity was decreased greatly during charging, as shown in FIG. 1D. This is due to the structural failure of graphite during the prelithiation reaction owing to the intercalation of solvated ions.

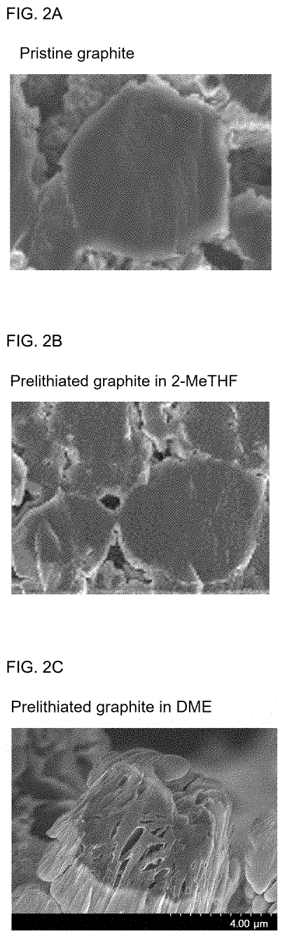

FIGS. 2A to 2C shows the scanning electron microscopy (SEM) images of the graphite electrodes prelithiated using the prelithiation solutions of Example 1 and Comparative Example 1 [FIG. 2A: pristine graphite as a control group, FIG. 2B: Example 1, and FIG. 2C: Comparative Example 1].

From FIGS. 2A to 2C, it can be seen that, whereas the morphology of graphite particles was maintained after chemical lithiation when 2-MeTHF was used as a solvent as in Example 1, there was a significant change in the microstructure of graphite when DME was used as a solvent as in Comparative Example 1. That is to say, it was confirmed that the change in voltage curve and the decrease in capacity electrochemically observed in FIGS. 1A to 1D are due to the change in the microstructure of graphite particles.

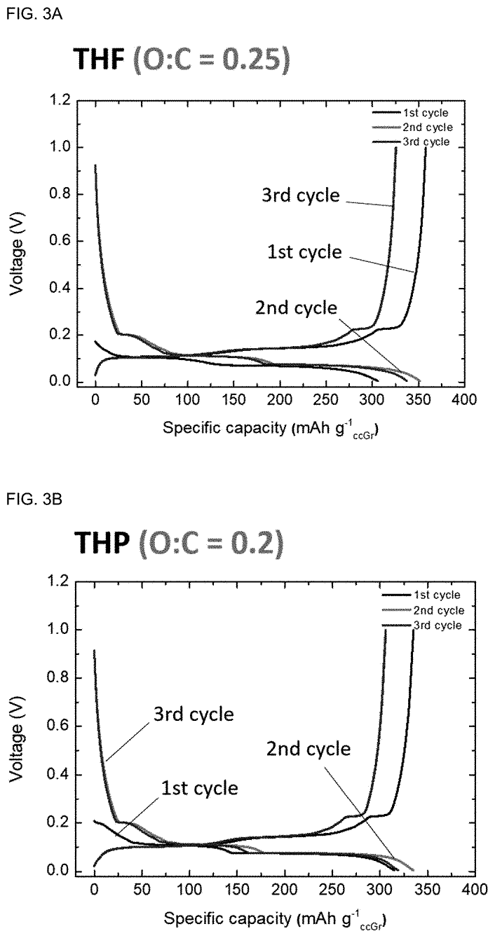

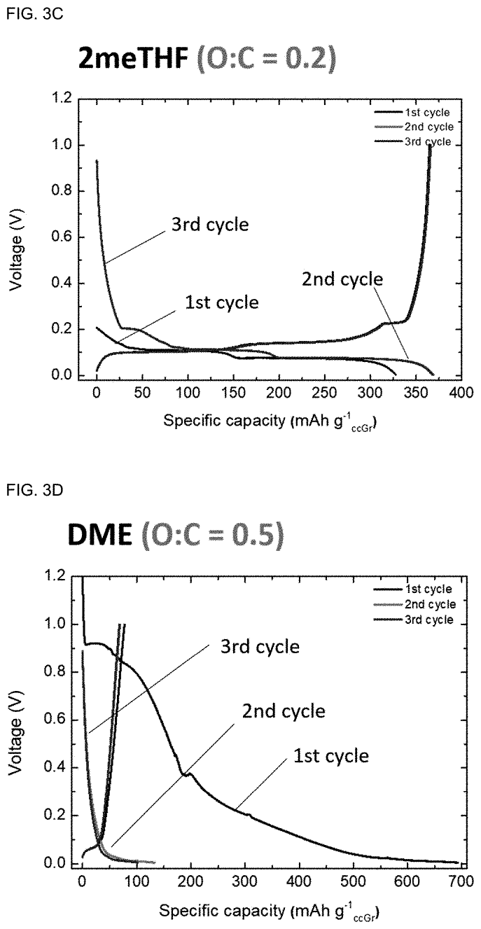

FIGS. 3A to 3D show the voltage curves of the graphite electrodes prelithiated using the prelithiation solutions of Examples 3-5 and Comparative Example 2 [FIG. 3A: Example 3, FIG. 3B: Example 4, FIG. 3C: Example 5, and FIG. 3D: Comparative Example 2].

As seen from FIGS. 3A to 3D, except for the case where DME was used as a solvent in Comparative Example 2, the OCV of the graphite electrode prelithiated with naphthalene was decreased remarkably as compared to the conventional pristine graphite similarly to the result for biphenyl, and the coulombic efficiency was observed to be 100% or higher. Through this, it was confirmed that stable chemical lithiation could be achieved without structural failure of graphite by using THF, THP or 2-MeTHF as a solvent.

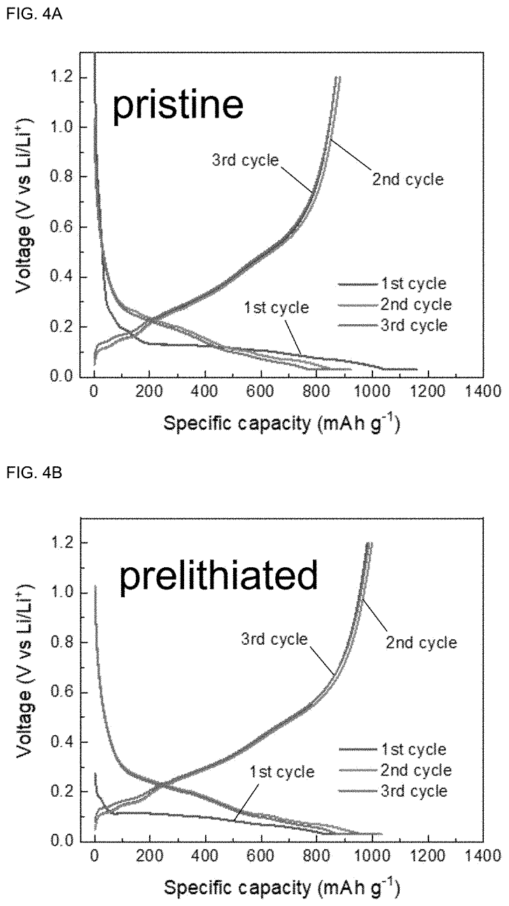

In addition, as the initial coulombic efficiency of the graphite/silicon composite anode was improved through the stable chemical prelithiation, the energy density of the full-cell including the prelithiated graphite/silicon composite anode was also improved. FIGS. 4A and 4B show the voltage curve of the graphite/silicon composite electrode prelithiated using the prelithiation solution of Example 6 [FIG. 4A: pristine graphite/silicon composite as a control group and FIG. 4B: Example 6].

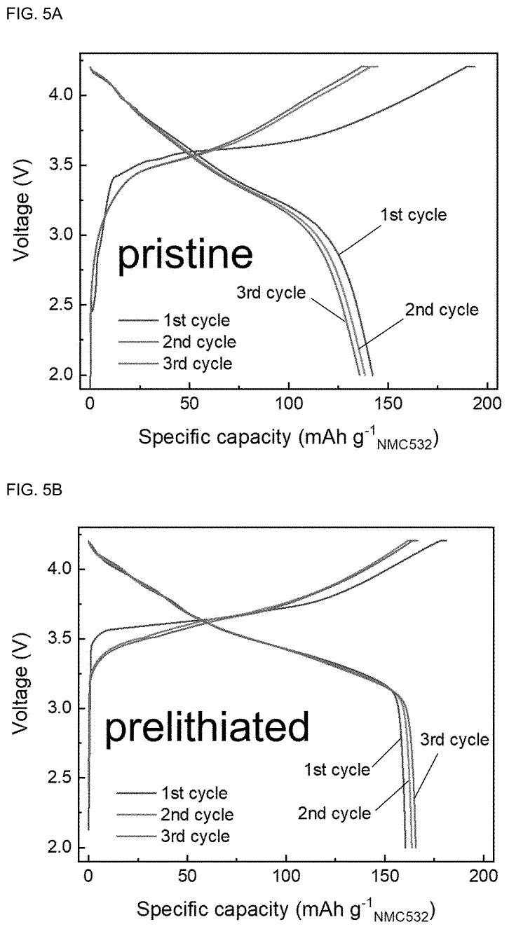

As seen from FIG. 5, the full-cell showed remarkably improvement in energy density after the prelithiation of the anode, which is attributed to the increased reversible capacity owing to the presence of extra active lithium after the prelithiation. While the discharge capacity was 142 mAh g⁻¹ and the initial coulombic efficiency was 73.5% prior to the prelithiation, the discharge capacity was 165 mAh g⁻¹ and the initial coulombic efficiency was 89% after the prelithiation.

FIGS. 5A and 5B show the voltage profile of the full-cell prelithiated using the prelithiation solution of Example 6 during the initial electrochemical cycle [FIG. 5A: LiNi_{0.5}Mn_{0.3}Co_{0.2}O₂∥pristine graphite/silicon full-cell and FIG. 5B: LiNi_{0.5}Mn_{0.3}Co_{0.2}O₂∥Example 6 graphite/silicon composite full-cell].

As seen from FIG. 5A, when the anode was not prelithiated, the initial efficiency was measured as 73.5% because of irreversible capacity and the reversible capacity of the cathode was 142-136 mAh g⁻¹ due to irreversible reaction. In contrast, as seen from FIG. 5B, when the prelithiation was performed successfully, the initial efficiency was 89% due to minimized irreversible capacity and the reversible capacity of the cathode was 161-165 mAh g⁻¹.

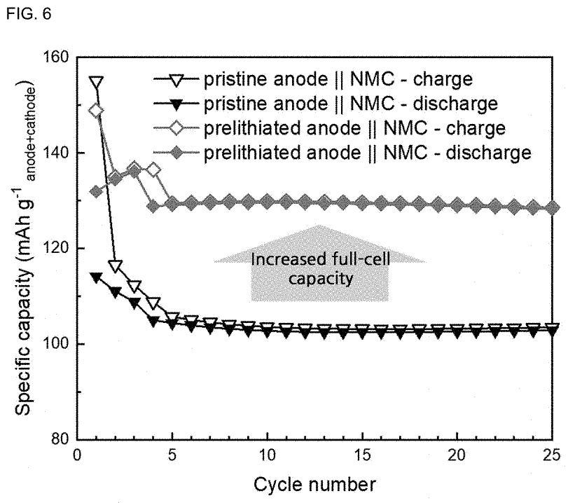

FIG. 6 shows the life characteristics of the full-cell shown in FIGS. 5A and 5B based on the total mass of the cathode and the anode. It was confirmed that the capacity of the full-cell using the prelithiated graphite/silicon composite anode was increased by 25 mAh g⁻¹ (based on the total mass of the anode ad the cathode) as compared to before the prelithiation and the cycle characteristics were maintained stably.

Therefore, according to the present disclosure, a prelithiation solution with a reduction potential 0.25 V (vs Li/Li⁺) or lower, which is capable of chemically intercalating lithium ions uniformly throughout a graphite or graphite composite anode in solution phase and capable of achieving high level of prelithiation, may be provided. In addition, an anode having an initial coulombic efficiency close to 100% may be provided by prelithiating a graphite or graphite composite anode using the prelithiation solution and a commercially applicable lithium secondary battery exhibiting high energy density may be provided based thereon.

What is claimed is:

1. A prelithiation solution for a graphite or graphite composite anode, comprising:
(a) a cyclic or linear ether-based solvent; and
(b) an aromatic hydrocarbon-lithium complex,
which has a reduction potential of 0.25 V (vs Li/Li⁺) or lower.

2. The prelithiation solution for a graphite or graphite composite anode according to claim 1, wherein the cyclic or linear ether-based solvent has a ratio of oxygen elements to carbon elements in the solvent of 0.25 or lower (O:C≤0.25).

3. The prelithiation solution for a graphite or graphite composite anode according to claim 2, wherein the cyclic ether-based solvent is methyltetrahydrofuran or tetrahydropyran.

4. The prelithiation solution for a graphite or graphite composite anode according to claim 1, wherein the aromatic hydrocarbon is a substituted or unsubstituted polycyclic aromatic compound having 10-22 carbon atoms except the substituent.

5. The prelithiation solution for a graphite or graphite composite anode according to claim 4, wherein the aromatic hydrocarbon is substituted or unsubstituted biphenyl or naphthalene.

6. A graphite or graphite composite anode prelithiated with the prelithiation solution according to claim 1.

7. The prelithiated graphite or graphite composite anode according to claim 6, which further comprises one or more selected from a group consisting of silicon (Si), silicon oxide (SiOₓ), silicon carbide (SiC), germanium (Ge), aluminum (Al), tin (Sn), gold (Au), silver (Ag), phosphorus (P), hard carbon and soft carbon.

8. A lithium secondary battery comprising:
(a) the prelithiated graphite or graphite composite anode according to claim 6;
(b) a cathode; and
(c) an electrolyte.
